(19) United States
(12) Patent Application Publication
(10) Pub. No.: US 2024/0386357 A1
(43) Pub. Date: Nov. 21, 2024

(54) EFFORTLESS CUSTOMER CONTACT AND INCREASED FIRST CALL RESOLUTION SYSTEM AND METHODS

(71) Applicant: NICE LTD., Ra’anana (IL)

(72) Inventors: LeAnn HOPKINS, Lake Worth/Wellington, FL (US); Matan KERET, OULU (FI); Noam KAPLAN, Tel-Aviv (IL); Rahul VYAS, Jodhpur (IN); Salil DHAWAN, Kharadi (IN)

(21) Appl. No.: 18/319,337

(22) Filed: May 17, 2023

(51) Int. Cl. G06Q 10/0639; G06N 3/044; G06Q 10/0631

(52) U.S. Cl. CPC G06Q 10/06393; G06N 3/044; G06Q 10/063112

(57) ABSTRACT

Classification and resolution systems and methods, and non-transitory computer readable media, including receiving a repeat interaction from a customer after a first interaction with a first agent; determining a history of the customer with the contact center, historical statistics of the first agent, skill statistics of the first agent, and contact center information on the first interaction; providing the history of the customer with the contact center, the historical statistics of the first agent, the skill statistics of the first agent, and the contact center information on the first interaction to a source classification model; automatically determining a source of the repeat interaction; automatically ranking based on the determined source of the repeat interaction, one or more reasons for the repeat interaction; and performing an action during the repeat interaction that corresponds to the one or more reasons for the repeat interaction to improve customer satisfaction.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for classifying and resolving repeat interactions, and more particularly to methods and systems that automatically determine and classify the source and the reason for a repeat interaction.

### BACKGROUND

One of the goals of contact centers is to conclude a service during the first contact made by customers. Current solutions are lacking a mechanism to identify and reduce customer frustration due to repeated interactions with the contact center. Repeated contacts also need to go through the interactive voice response (IVR) queue and hold every time.

Moreover, contact centers are lacking a mechanism to identify repeat interactions and thus train the agents who cause more of these repeat interactions. Contact centers are also lacking a way to identify general inefficient or problematic organizational processes.

Accordingly, a need exists for improved systems and methods to address these issues.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a contact center according to various aspects of the present disclosure.

FIG. 2 is a more detailed block diagram of the contact center of FIG. 1 according to aspects of the present disclosure.

FIG. 3 is a simplified diagram of a data flow according to embodiments of the present disclosure.

FIG. 4 illustrates the transformation of collected data at a high level according to embodiments of the present disclosure.

FIG. 5 illustrates the collected data from different sources according to embodiments of the present disclosure.

FIG. 6 illustrates the processing and vectorization architecture according to embodiments of the present disclosure.

FIG. 7 illustrates a hierarchical classification model according to embodiments of the present disclosure.

FIG. 8 provides an overview of the machine learning model architecture according to embodiments of the present disclosure.

FIG. 9 is a flowchart of a method according to embodiments of the present disclosure.

FIG. 10 is an exemplary user interface for quality management according to embodiments of the present disclosure.

FIG. 11 is a block diagram of a computer system suitable for implementing one or more components in FIG. 1 or FIG. 2 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods increase first call resolution in the contact center by analysis of repeat interactions (e.g., a second or third call from a customer after a first call from the customer) and then acting on that analysis. A machine learning (ML) model classifies the repeat interaction in two phases. First, the ML model determines the source of the repeat interaction. In certain embodiments, the source of the repeat interaction can be the customer (e.g., additional/new query from the customer), the agent (e.g., the agent provides unclear or inaccurate instructions), or a contact center process (e.g., a customer did not receive a text as promised). Second, the ML model classifies the reason for the repeat interaction. For example, if the source of the repeat interaction is the customer, there may be different reasons that are associated with the customer. The customer may not have been paying attention when instructions were provided, or the customer may have thought of another question after the first interaction was concluded.

By classifying a source and a reason for a repeat interaction (there may be multiple sources and multiple reasons for a repeat interaction), agent efficiency, improved contact center processes (e.g., to reduce future repeat interactions), and customer satisfaction on repeat customer interactions can be achieved. In certain embodiments, agent efficiency is improved by deriving a key performance indicator (KPI) for increasing first call resolution. Utilization of a repeat interaction KPI score helps quality management of an organization assign relevant training programs to agents, or relevant rewards and recognition can be assigned to agents by using a gamification module. Contact center processes are improved by identifying and presenting ineffective processes that require attention. Customer satisfaction is improved since repeat interactions are identified and can often skip the queue. Accordingly, the present methods and systems increase first call resolution and reduce costs. In addition, workforce management (WFM) flows are enhanced, and business/system flaws are discovered.

The use of ML is unique, and it removes the need for manual root cause analysis and detection of interactions by an organization's analysts or quality management personnel. Importantly, current solutions to meet the needs in the industry tend to be entirely or primarily manual. For example, analytic teams may have to build speech analytic categories to identify repeat callers. Then they conduct manual root cause analysis as an attempt to resolve future repeat interactions, which is a reactive approach and not preventative. The quantifiable findings are as impactful as the building of the category. It also requires analytic skills of the analytics team. The quality team is responsible for finding opportunities where the agent could have done better to prevent a repeat interaction on a very minimal sample of interactions, which are not statistically relevant based on true volume. This is provided a case-by-case resolution model, which has proven to be ineffective.

Advantageously, the present methods and systems reduce the unforecasted volume into the contact center while improving customer satisfaction by delivering meticulous treatment in cases of interactions being disconnected unexpectedly or not being completely resolved before disconnecting. Lack of current business strategy in the industry, along with lack of expertise with ML tends to result in these issues in the art. The present systems and methods, however, identify gaps within call center processes, poor first call resolution, process gaps, and lack of effective agent training, to create operational alternatives to increase efficiency and first-time interaction resolution.

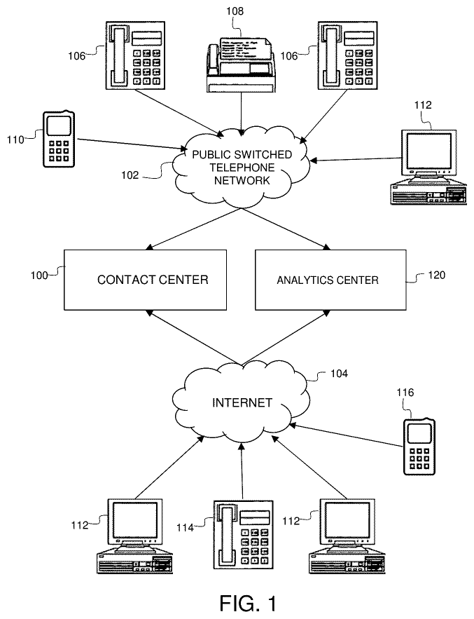

FIG. 1 is a simplified block diagram of an embodiment of a contact center 100 according to various aspects of the present disclosure. The term “contact center,” as used herein, can include any facility or system server suitable for receiving and recording electronic communications from contacts. Thus, it should be understood that the term “call” includes other forms of contact as described herein than merely a phone call. Such contact communications can include, for example, call interactions, chats, facsimile transmissions, e-mails, web interactions, voice over IP (“VOIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a customer (or caller) and a contact center agent during fulfillment of a customer and agent transaction. In one embodiment, the contact center 100 records all of the customer interactions in uncompressed audio formats. In the illustrated embodiment, customers may communicate with agents associated with the contact center 100 via multiple different communication networks such as a public switched telephone network (PSTN) 102 or the Internet 104. For example, a customer may initiate an interaction session through traditional telephones 106, a fax machine 108, a cellular (i.e., mobile) telephone 110, a personal computing device 112 with a modem, or other legacy communication device via the PSTN 102. Further, the contact center 100 may accept internet-based interaction sessions from personal computing devices 112, VoIP telephones 114, and internet-enabled smartphones 116 and personal digital assistants (PDAs). Thus, in one embodiment, “call” means a voice interaction such as by traditional telephony or VoIP.

As one of ordinary skill in the art would recognize, the illustrated example of communication channels associated with a contact center 100 in FIG. 1 is just an example, and the contact center may accept customer interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics center 120 before reaching the contact center 100 or may be routed simultaneously to the contact center and the analytics center (or even directly and only to the contact center). Also, in some embodiments, internet-based interactions may be received and handled by a marketing department associated with either the contact center 100 or analytics center 120. The analytics center 120 may be controlled by the same entity or a different entity than the contact center 100. Further, the analytics center 120 may be a part of, or independent of, the contact center 100.

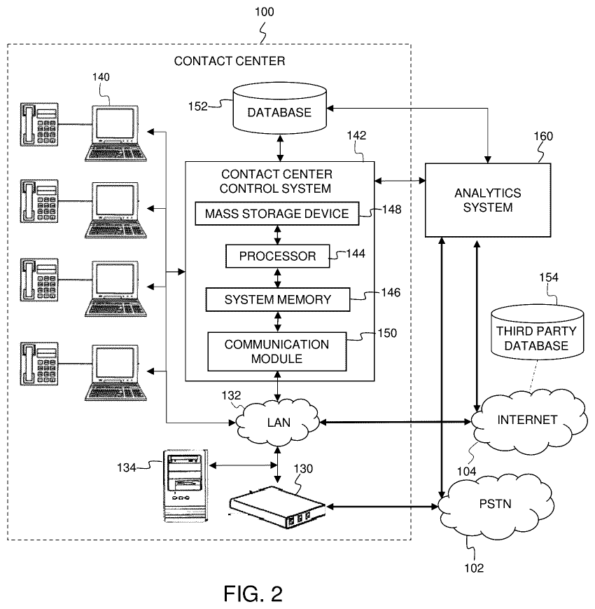

FIG. 2 is a more detailed block diagram of an embodiment of the contact center 100 according to aspects of the present disclosure. As shown in FIG. 2, the contact center 100 is communicatively coupled to the PSTN 102 via a distributed private branch exchange (PBX) switch 130 and/or ACD 130. The PBX switch 130 provides an interface between the PSTN 102 and a local area network (LAN) 132 within the contact center 100. In general, the PBX switch 130 connects trunk and line station interfaces of the PSTN 102 to components communicatively coupled to the LAN 132. The PBX switch 130 may be implemented with hardware or virtually. A hardware-based PBX may be implemented in equipment located local to the user of the PBX system. In contrast, a virtual PBX may be implemented in equipment located at a central telephone service provider that delivers PBX functionality as a service over the PSTN 102. Additionally, in one embodiment, the PBX switch 130 may be controlled by software stored on a telephony server 134 coupled to the PBX switch. In another embodiment, the PBX switch 130 may be integrated within telephony server 134. The telephony server 134 incorporates PBX control software to control the initiation and termination of connections between telephones within the contact center 100 and outside trunk connections to the PSTN 102. In addition, the software may monitor the status of all telephone stations coupled to the LAN 132 and may be capable of responding to telephony events to provide traditional telephone service. In certain embodiments, this may include the control and generation of the conventional signaling tones including without limitation dial tones, busy tones, ring back tones, as well as the connection and termination of media streams between telephones on the LAN 132. Further, the PBX control software may programmatically implement standard PBX functions such as the initiation and termination of telephone calls, either across the network or to outside trunk lines, the ability to put calls on hold, to transfer, park and pick up calls, to conference multiple callers, and to provide caller ID information. Telephony applications such as voice mail and auto attendant may be implemented by application software using the PBX as a network telephony services provider.

Often, in contact center environments such as contact center 100, it is desirable to facilitate routing of customer communications, particularly based on agent availability. prediction of profile (e.g., personality type) of the customer occurring in association with a contact interaction, and/or matching of contact attributes to agent attributes, be it a telephone-based interaction, a web-based interaction, or other type of electronic interaction over the PSTN 102 or Internet 104. In various embodiments, ACD 130 is configured to route customer interactions to agents based on availability, profile, and/or attributes.

In one embodiment, the telephony server 134 includes a trunk interface that utilizes conventional telephony trunk transmission supervision and signaling protocols required to interface with the outside trunk circuits from the PSTN 102. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The telephony server 134 includes hardware and software components to interface with the LAN 132 of the contact center 100. In one embodiment, the LAN 132 may utilize IP telephony, which integrates audio and video stream control with legacy telephony functions and may be supported through the H.323 protocol. H.323 is an International Telecommunication Union (ITU) telecommunications protocol that defines a standard for providing voice and video services over data networks. H.323 permits users to make point-to-point audio and video phone calls over a local area network. IP telephony systems can be integrated with the public telephone system through an IP/PBX-PSTN gateway, thereby allowing a user to place telephone calls from an enabled computer. For example, a call from an IP telephony client within the contact center 100 to a conventional telephone outside of the contact center would be routed via the LAN132 to the IP/PBX-PSTN gateway. The IP/PBX-PSTN gateway would then translate the H.323 protocol to conventional telephone protocol and route the call over the PSTN 102 to its destination. Conversely, an incoming call from a contact over the PSTN 102 may be routed to the IP/PBX-PSTN gateway, which translates the conventional telephone protocol to H.323 protocol so that it may be routed to a VoIP-enable phone or computer within the contact center 100.

The contact center 100 is further communicatively coupled to the Internet 104 via hardware and software components within the LAN 132. One of ordinary skill in the art would recognize that the LAN 132 and the connections between the contact center 100 and external networks such as the PSTN 102 and the Internet 104 as illustrated by FIG. 2 have been simplified for the sake of clarity and the contact center may include various additional and/or different software and hardware networking components such as routers, switches, gateways, network bridges, hubs, and legacy telephony equipment.

As shown in FIG. 2, the contact center 100 includes a plurality of agent workstations 140 that enable agents employed by the contact center 100 to engage in customer interactions over a plurality of communication channels. In one embodiment, each agent workstation 140 may include at least a telephone and a computer workstation. In other embodiments, each agent workstation 140 may include a computer workstation that provides both computing and telephony functionality. Through the workstations 140, the agents may engage in telephone conversations with the customer, respond to email inquiries, receive faxes, engage in instant message conversations, text (e.g., SMS, MMS), respond to website-based inquires, video chat with a customer, and otherwise participate in various customer interaction sessions across one or more channels including social media postings (e.g., Facebook, LinkedIn, etc.). Further, in some embodiments, the agent workstations 140 may be remotely located from the contact center 100, for example, in another city, state, or country. Alternatively, in some embodiments, an agent may be a software-based application configured to interact in some manner with a customer. An exemplary software-based application as an agent is an online chat program designed to interpret customer inquiries and respond with pre-programmed answers.

The contact center 100 further includes a contact center control system 142 that is generally configured to provide recording, voice analysis, fraud detection analysis, behavioral analysis, text analysis, storage, and other processing functionality to the contact center 100. In the illustrated embodiment, the contact center control system 142 is an information handling system such as a computer, server, workstation, mainframe computer, or other suitable computing device. In other embodiments, the control system 142 may be a plurality of communicatively coupled computing devices coordinated to provide the above functionality for the contact center 100. The control system 142 includes a processor 144 that is communicatively coupled to a system memory 146, a mass storage device 148, and a communication module 150. The processor 144 can be any custom made or commercially available processor, a central processing unit (CPU), an auxiliary processor among several processors associated with the control system 142, a semiconductor-based microprocessor (in the form of a microchip or chip set), a microprocessor, a collection of communicatively coupled processors, or any device for executing software instructions. The system memory 146 provides the processor 144 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data, such as voice prints, may be stored on the mass storage device 148. Examples of mass storage devices may include hard discs, optical disks, magneto-optical discs, solid-state storage devices, tape drives, CD-ROM drives, and/or a variety other mass storage devices known in the art. Further, the mass storage device may be implemented across one or more network-based storage systems, such as a storage area network (SAN). The communication module 150 is operable to receive and transmit contact center-related data between local and remote networked systems and communicate information such as contact interaction recordings between the other components coupled to the LAN 132. Examples of communication modules may include Ethernet cards, 802.11 WiFi devices, cellular data radios, and/or other suitable devices known in the art. The contact center control system 142 may further include any number of additional components, which are omitted for simplicity, such as input and/or output (I/O) devices (or peripherals), buses, dedicated graphics controllers, storage controllers, buffers (caches), and drivers. Further, functionality described in association with the control system 142 may be implemented in software (e.g., computer instructions), hardware (e.g., discrete logic circuits, application specific integrated circuit (ASIC) gates, programmable gate arrays, field programmable gate arrays (FPGAs), etc.), or a combination of hardware and software.

According to one aspect of the present disclosure, the contact center control system 142 is configured to record, collect, and analyze customer voice data and other structured and unstructured data, and other tools may be used in association therewith to increase efficiency and efficacy of the contact center. As an aspect of this, the control system 142 is operable to record unstructured interactions between customers and agents occurring over different communication channels including without limitation call interactions, email exchanges, website postings, social media communications, smartphone application (i.e., app) communications, fax messages, texts (e.g., SMS, MMS, etc.), and instant message conversations. An unstructured interaction is defined herein as a voice interaction between two persons (e.g., between an agent of the contact center 100 such as call center personnel or a chatbot, and a caller of the contact center 100, etc.) that include phrases that are not predetermined prior to the voice interaction. An example of an unstructured interaction may include the agent asking the caller “what can I help you with today,” to which the caller may answer with any possible answers. By contrast, a structured interaction is defined as a sequence of phrases between the two persons that are predetermined prior to the voice interaction. An example structured interaction may include the agent asking the caller “are you looking to change an address or withdraw money today,” to which the caller may only be able to answer based on any one of the two predetermined phrases—“change an address” or “withdraw money.”

The control system 142 may include a hardware or software-based recording server to capture the audio of a standard or VoIP telephone connection established between an agent workstation 140 and an outside contact telephone system. Further, the audio from an unstructured telephone call or video conference session (or any other communication channel involving audio or video, e.g., a Skype call) may be transcribed manually or automatically and stored in association with the original audio or video. In one embodiment, multiple communication channels (i.e., multi-channel) may be used, either in real-time to collect information, for evaluation, or both. For example, control system 142 can receive, evaluate, and store telephone calls, emails, and fax messages. Thus, multi-channel can refer to multiple channels of interaction data, or analysis using two or more channels, depending on the context herein.

In addition to unstructured interaction data such as interaction transcriptions, the control system 142 is configured to captured structured data related to customers, agents, and their interactions. For example, in one embodiment, a “cradle-to-grave” recording may be used to record all information related to a particular telephone call from the time the call enters the contact center to the later of: the caller hanging up or the agent completing the transaction. All or a portion of the interactions during the call may be recorded, including interaction with an IVR system, time spent on hold, data keyed through the caller's keypad, conversations with the agent, and screens displayed by the agent at his/her station during the transaction. Additionally, structured data associated with interactions with specific customers may be collected and associated with each customer, including without limitation the number and length of calls placed to the contact center, call origination information, reasons for interactions, outcome of interactions, average hold time, agent actions during interactions with the customer, manager escalations during calls, types of social media interactions, number of distress events during interactions, survey results, and other interaction information, or any combination thereof. In addition to collecting interaction data associated with a customer, the control system 142 is also operable to collect biographical profile information specific to a customer including without limitation customer phone number, account/policy numbers, address, employment status, income, gender, race, age, education, nationality, ethnicity, marital status, credit score, contact “value” data (i.e., customer tenure, money spent as customer, etc.), personality type (as determined based on past interactions), and other relevant customer identification and biological information, or any combination thereof. The control system 142 may also collect agent-specific unstructured and structured data including without limitation agent personality type, gender, language skills, technical skills, performance data (e.g., customer retention rate, etc.), tenure and salary data, training level, average hold time during interactions, manager escalations, agent workstation utilization, and any other agent data relevant to contact center performance, or any combination thereof. Additionally, one of ordinary skill in the art would recognize that the types of data collected by the contact center control system 142 that are identified above are simply examples and additional and/or different interaction data, customer data, agent data, and telephony data may be collected and processed by the control system 142.

The control system 142 may store recorded and collected interaction data in a database 152, including customer data and agent data. In certain embodiments, agent data, such as agent scores for dealing with customers, are updated daily or at the end of an agent shift.

The control system 142 may store recorded and collected interaction data in a database 152. The database 152 may be any type of reliable storage solution such as a RAID-based storage server, an array of hard disks, a storage area network of interconnected storage devices, an array of tape drives, or some other scalable storage solution located either within the contact center or remotely located (i.e., in the cloud). Further, in other embodiments, the contact center control system 142 may have access not only to data collected within the contact center 100 but also data made available by external sources such as a third party database 154. In certain embodiments, the control system 142 may query the third party database for contact data such as credit reports, past transaction data, and other structured and unstructured data.

Additionally, in some embodiments, an analytics system 160 may also perform some or all of the functionality ascribed to the contact center control system 142 above. For instance, the analytics system 160 may record telephone and internet-based interactions, convert discussion to text (e.g., for linguistic analysis or text-dependent searching) and/or perform behavioral analyses. The analytics system 160 may be integrated into the contact center control system 142 as a hardware or software module and share its computing resources 144, 146, 148, and 150, or it may be a separate computing system housed, for example, in the analytics center 120 shown in FIG. 1. In the latter case, the analytics system 160 includes its own processor and non-transitory computer-readable storage medium (e.g., system memory, hard drive, etc.) on which to store analytics software and other software instructions.

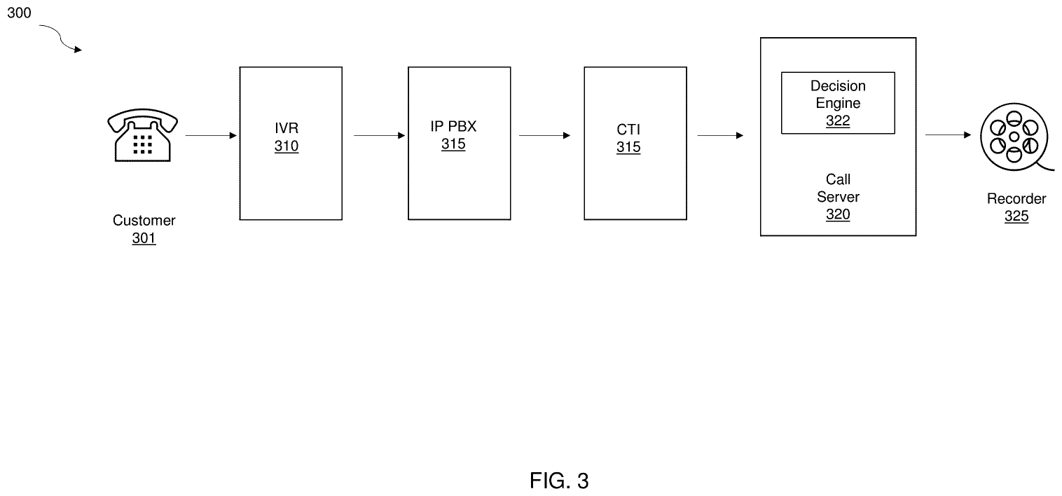

FIG. 3 illustrates the data flow according to certain embodiments of the present disclosure. In one or more embodiments, customer 301 calls, for example, the contact center 100. The call is processed via IVR 310 and IP PBX 315. Information regarding the call, as well as previous information about the customer and the agent, are passed to call server 320 via a Computer Telephony Integration (CTI) component 315. CTI component 315 provides this metadata to call server 320, where decision engine 322 resides and the smart decision regarding the source and reasons for the call is made. Decision engine 322 classifies the call and provides inputs to IVR 310 as to where to route the call next. Call server 320 may also use the decision made by Decision Engine 322 to start recording the call via recorder 325.

### Classification Scheme

In one or more embodiments, a classification scheme is configured first. The classification scheme may be adapted to different tenants or clients. Table 1 below provides an example classification scheme, which includes a classification of source, a classification of reason, and an action to be taken.

TABLE 1
CLASSIFICATION SCHEME

| Source | | | |
|---|---|---|---|
| (Level 1 | | Reason | |
| classification) | | (Level 2 classification | Action |
| 1. | Customer | Customer lack of attentiveness | Reconnect to agent no wait |
| | | Customer did not understand the | Reconnect to agent no wait |
| | | resolution properly. | |
| | | Customer thought of another follow | Regular waiting |
| | | up question after he hung the phone | |
| | | up. | |
| 2. | Contact | Process gap | Reconnect to agent no wait |
| | center | Lack of adequate process for | Reconnect to agent no wait |
| | process | providing communication. | |
| | | Broken back-office customer | Reconnect to agent no wait |
| | | relationship management (CRM) | |
| | | impacting customer requests to be | |
| | | processes (i.e., billing statements to | |
| | | be re-sent, credits to be applied, | |
| | | etc.). | |
| | | Routing skills are not optimized | Notify supervisor and log |
| | | | for future inspection |
| 3. | Agent | Incomplete communication and | Reconnect to agent no wait |
| | | knowledge were provided to the | |
| | | customer by the agent | |
| | | Lack of agent skills | Reconnect to different agent |
| | | Agent misguides the customer and | Reconnect to different agent |
| | | doesn't provide correct information | |
| | | Breach of commitment. | Reconnect to different agent |
| | | Agent did not process the customer | Reconnect to agent no wait |
| | | request using the correct codes in | |
| | | the CRM. | |
| | | Agent did not collect all the | Reconnect to agent no wait |
| | | pertinent information from the | |
| | | customer, blocking the Back Office | |
| | | form completing the request. | |

In some embodiments, classification for the source of a repeat interaction in a high-level manner is performed first, and is followed by classification of the reason, which varies depending on the source. Each of the three main sources in this example (e.g., customer, contact center process, and agent) has a variety of reasons that are associated with it. The number of these reasons, as well as the number of sources, is completely configurable and can be adjusted to the specific contact center's needs.

As can be seen from Table 1, agent efficiency can be improved based on classification of the source and reason for a repeat interaction. In one embodiment, agent KPI is impacted based on the classification of the source. If the customer or the contact center is the source of the repeat interaction, the agent KPI is not impacted. In some embodiments, agent KPI may be improved if the agent patiently replies to the same customer again and again. On the other hand, if the agent is the source of the repeat interaction, agent KPI is impacted. The organization may choose to perform gamification around this KPI, i.e., educate and/or train the agent to improve any deficient aspect of interaction performance via one or more games. In certain embodiments, organizations collect this KPI over time and motivate the agents to improve it and increase first call resolution as a result.

Customer satisfaction can also be improved based on classification of the source and reasons for a repeat interaction. In one or more embodiments, a repeat interaction reconnection buffer period is initiated after an interaction ends. If a customer calls back within the buffer period, then his/her call may be directly reconnected to the relevant agent and tagged accordingly. In an embodiment, if both the customer and the agent agree that a given query has been resolved, and after some time (within the buffer period), the customer calls back again, then the customer is connected to the same agent immediately. In various embodiments, the repeat interaction agent KPI is evaluated for the agent. In another embodiment, if there is an expected disconnection during the interaction (e.g., an agent works from home and the call is accidentally dropped, the customer is driving and enters a mobile dead spot, which causes the call to drop, or the agent is transferring the customer and the call drops due to the wrong button being pushed by the agent), the customer is also connected to the same agent immediately. In yet another embodiment, if there is outstanding action in relation to the customer, the customer is also connected to the same agent immediately during a repeat interaction. For example, if a technician was scheduled to arrive, and the repeat interaction is about that outstanding action, then the customer is connected to the same agent.

For instance, when a customer calls a contact center to report that electricity is not working in the home, the customer is provided with an expected handling time of one hour. The one hour passed, and the same customer is calling again, as the issue was not handled as promised. Assuming enough data of repeat callers has been collected, call server 320 reviews all the metadata of the customer, their previous contact information, and open tickets they may have with the organization. Based on the ML algorithms (e.g., the source classification model and the reason ranking model), decision engine 322 automatically classifies the source and the reason for the repeat interaction and handles accordingly.

In the above case, the ticket of the customer was not handled, and the customer called back within the reconnection buffer period. Therefore the customer is swiftly passed to the same handling agent or someone from their team. If the time that had passed had been significantly higher (such as three days), then decision engine 322 would consider the call to be a new/different query and handle accordingly.

Generally, the source and reason for a returning or repeat interaction is used to improve the repeat interaction, making it both a better experience for the customer, as well as improving contact center utilization. If the customer was the source and the reason was that he/she did not understand the resolution properly, he/she is reconnected to the same agent, saving wait time for the customer and agent time by connecting to an agent that is aware of the previous contact details. If the source was the agent and the reason was lack of skills, a no-wait reconnect would occur to a different agent.

### Data Collection

Once the classification scheme is set up, data collection begins. During this stage, customers are given the ability to provide the source and the reason during the initial wait in the queue. For example, customers may be prompted to provide a reason for a repeat interaction on the IVR system. When decision engine 322 receives the reason for the repeat interaction, call server 320 can perform the required action as configured in Table 1 above. In some embodiments, the agent is polled after the repeat interaction is completed if necessary to facilitate determining the source and the reason for the repeat interaction. Once an initial period (e.g., a month) has passed, or a preconfigured number of repeat interactions (e.g., 1000) have been tagged, call server 320 can proceed into the training phase. Before using the data for training, however, the data is typically transformed.

### Data Transformation

Data is collected from multiple sources, facilitating enough information for the ML models to make an informed prediction regarding source and reason for a repeat interaction. In various embodiments, call server 320 collects a wide assortment of features and concatenates them. The data collection process extracts multiple modalities of data, including numerical data (e.g., time since previous contact), categorical data (e.g., inbound or outbound call), and other possible types of data such as textual data. Table 2 illustrates a subset of collected features and how they are transformed.

TABLE 2
DIFFERENT VALUE HANDLING BY VECTORIZERS

| | | Original | | Value after | Is part of |
|---|---|---|---|---|---|
| Source | Feature | value type | Transformation | transformation | sequence |
| Contact | Time | Integer | Standard | Float | Yes |
| info | since | | normalization | | |
| | previous | | | | |
| | call | | | | |
| Contact | Direction | Categorical | Binarization | Inbound −> [0, 1] | Yes |
| info | | | | Outbound −> [1, 0] | |
| Skill | % issues | Float [0-100] | Standard | Float | No |
| info | due to | | normalization | | |
| | customer | | | | |

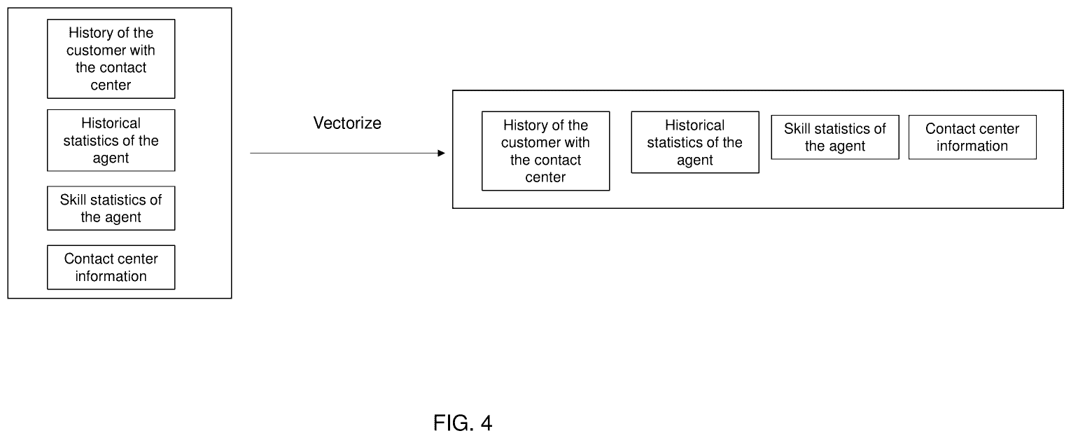

The final goal of all transformations is to process a multi-source, multi-data type input into a single vector for the classification process. As seen in FIG. 4, the inputs to the ML algorithm of the history of the customer with the contact center (e.g., contact information sequence), the historical statistics of the agent, the skill statistics of the agent, and the contact center are vectorized into a single vector before this data is provided to the ML algorithm. This high level transformation represents a complicated process of data transformation, partly done using a trained recurrent neural network (RNN) that helps transform sequential data into vector form containing relevant transformation data. An RNN is a class of artificial neural networks where connections between nodes can create a cycle, allowing output from some nodes to affect subsequent input to the same nodes. This allows it to exhibit temporal dynamic behavior.

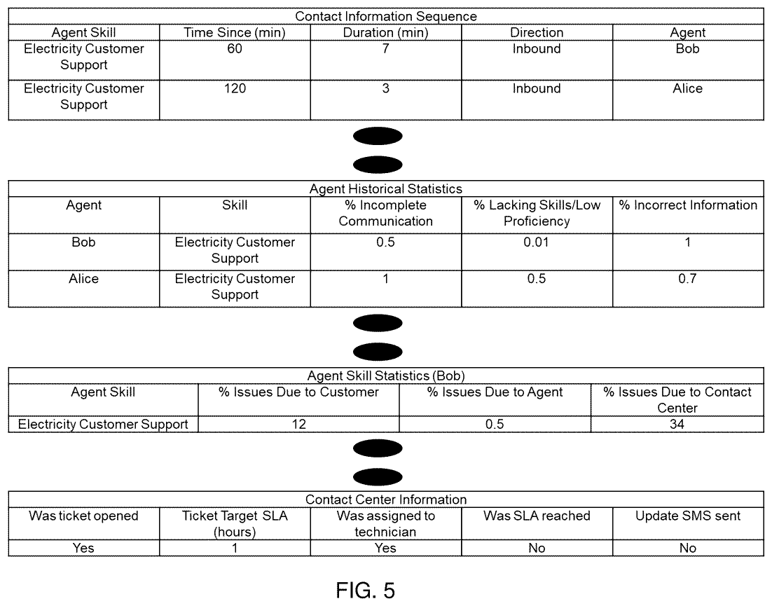

FIG. 5 is a detailed simulation of the data gathered. In this data, there are multiple sources of aggregated data, including contact information sequence, agent historical statistics, agent skill statistics, and contact center information. Contact information sequence specifically refers to previous instances of interactions from the customer that the current repeat interaction is a continuation of. Multiple rows in this context describe a sequence of events that happened chronologically and must be processed in the same way to provide the right classification and solution to the customer.

In FIG. 5, the customer is calling every hour, and the purpose of the call is the same. Based on the agent historical statistics, the agents have good statistics in the skill so the agent is not likely the source of the problem. The system service level agreement (SLA) was not met. Thus, the contact center processes are very highly likely the error source.

It is important to notice that while two out of the four tables described in FIG. 5 have multiple rows, only the contact information sequence represents a sequence of chronological events. The original interaction with the customer and the following interaction represent a series of events with important details in the story. For each row in the contact information sequence table, a row may exist in the agent historical statistics, providing additional information on how the specific agent handling this interaction had performed in the past. The agent skill statistics for the same interaction row has general statistics for the same skill, describing what in general tends to occur with this skill, regardless of the agent context.

In order to process each sequential element from the contact information sequence, an architecture of vectorizers, concatenation, and processing using a long short-term memory (LSTM) system was developed. LSTM is an artificial neural network used in the fields of artificial intelligence and deep learning, and has feed connection. Such an RNN can process not only single data points (such as images), but also entire sequences of data (such as speech or video).

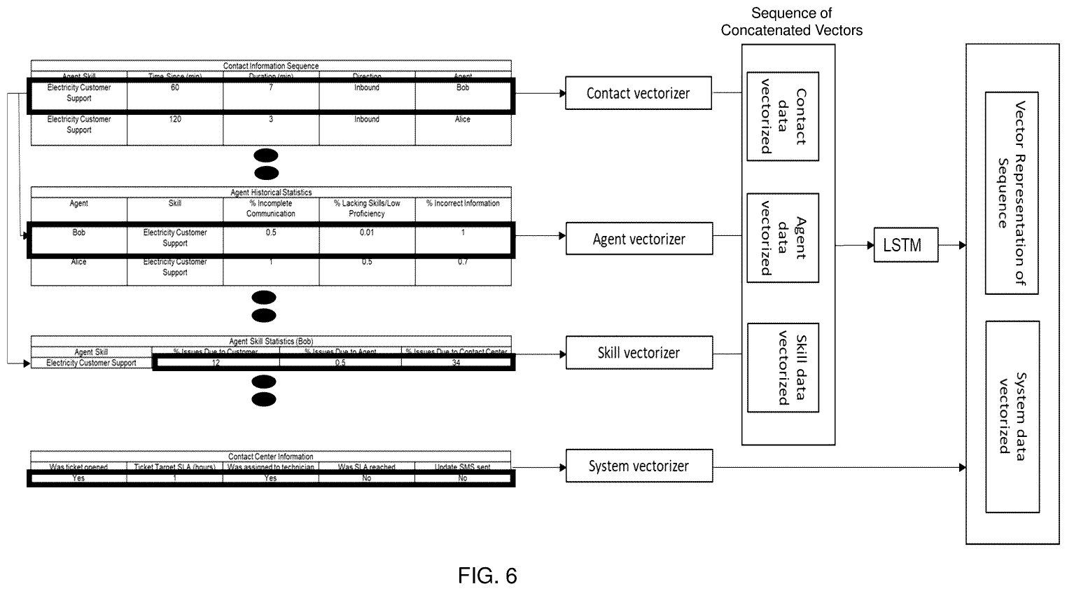

FIG. 6 describes a flow for data processing, collecting different elements of data from different sources, and transforming the data into a single vector using a combination of single value transformations, concatenation, and sequential neural networks. In particular, FIG. 6 presents four vectorizer elements—a contact vectorizer, an agent vectorizer, a skill vectorizer, and a system vectorizer. These are not trained algorithms, but standard mathematical objects that transform the different pieces of information into a standard form of numbers, rendering them both in a similar value range, as well as transforming categorical data into a binary representation that can be concatenated as part of a larger vector representation to facilitate further analysis. Elements from the contact information sequence, such as the skill name, are not vectorized on their own, but are used as lookup keys for data in the skill data source and the agent historical statistics data source, with multiple data sources combined within each element in the sequence.

The sequence of concatenated vectors includes one vector for every row in the contact information sequence table, with multiple data sources combined with each element in the sequence. These vectors are then fed into the RNN, which in this example, is represented specifically by an LSTM. The RNN outputs a sequence of vectors of the same length, from which only the final vector is taken, as is common practice when transforming a sequence of vectors into a single vector using an RNN.

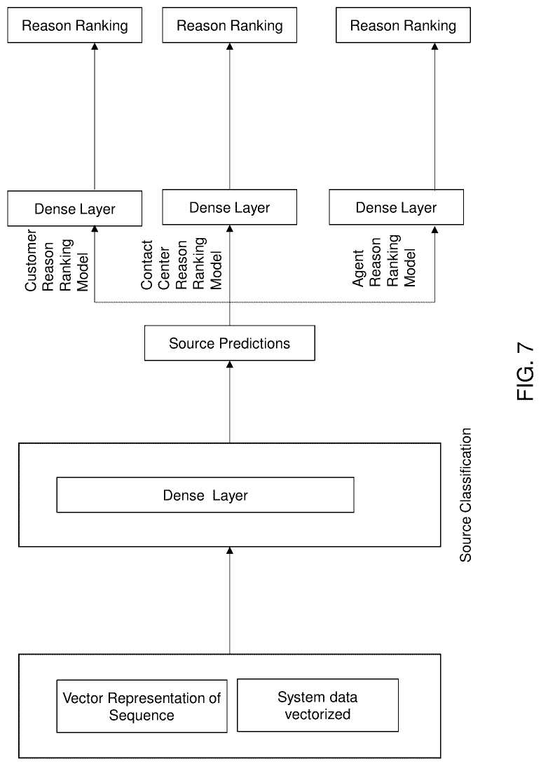

The single vector representing the full contact information sequence is then concatenated to the vectorized data retrieved from the contact center information. The contact center information is not a part of the sequence as it does not play a part in representing any facet of the sequential data. The result of this final concatenation is the final step of the vectorization process. The resulting vector is then fed into the hierarchical model of FIG. 7.

### Machine Learning

### Training

During this phase, the models are trained weekly and evaluated until the model reaches a certain pre-set accuracy level (e.g., larger than 80%, 85%, or 90%). Upon reaching this threshold (or a different preconfigured number), the training phase is complete and decision engine 322 proceeds to the final automated repeat interaction phase, where the models are used to predict the source and the reason automatically. In certain embodiments, the customer is polled, and the output of the models are compared to the customer response. Call server 320 then performs an action based on customer feedback and the reconnection buffer period.

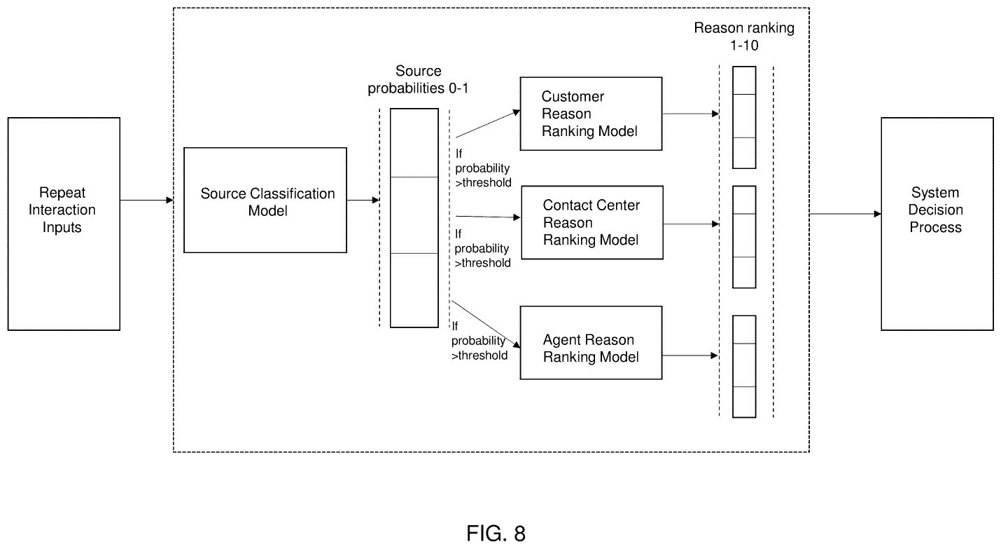

Referring now to FIG. 8, the repeat interaction inputs include previous contact history (e.g., day, time, skill, duration, and direction), historical agent statistics (e.g., percentage of repeat interactions for each reason, and the average score for each reason), agent skill statistics (e.g., percentage of repeat interactions for each reason), interaction statistics (e.g., previous repeat interaction reasons), and other system/business data (SLAs, alerting SMS, etc.).

The first box in FIG. 7 represents the vectorized data representing the full sequence and the system data from FIG. 6. This is used as input into the source classification model. In particular, this vector serves as the input to the source classification dense layer, which performs classification into one of three main sources, as described above. As seen in FIG. 8, the shape of the resulting output is |1×3|, where three is the number of sources in this example.

In FIG. 8, each element of the three outputs of the source classification model is a probability for the input source of the repeat interaction originating from a specific source. If the probability is greater than a threshold probability, then the method continues to the reason ranking model. The classification output and the vectorized data from the first box in FIG. 7 is fed as input for each of the three dense layers that are trained to predict the ranking outputs. The shape of these outputs for each of these dense layers is |1×number of reasons|, and the value predicted for each reason is a value in the range of 1-10 (as shown in FIG. 8), based on customer polling during the data collection phase. There are different reasons depending on the source of the repeat interaction. For example, if the source is the agent, missing communication can be ranked 2 and lack of skills can be ranked 7. These reasons can then be used by call server 320 to determine a decision and the action to be taken.

TABLE 3
OUTPUTS OF SOURCE CLASSIFICATION
MODEL AND REASON RANKING MODEL

| Level | Model | Activation | Outputs |
|---|---|---|---|
| 1 | Source | Always | Probability vector |
| | Classification | | for three sources |
| 2 | Customer Reason | If source is the | Ranking vector for |
| | | customer | customer reasons |
| | | | with values 1-10 |
| 2 | Contact Center | If source is the | Ranking vector for |
| | Reason | contact center | contact center reasons |
| | | | with values 1-10 |
| 2 | Agent Reason | If source is the | Ranking vector for |
| | | agent | agent reasons with |
| | | | values 1-10 |

### Automated Recaller Classification

Once the models are trained, they are used to predict the source and the reasons for the repeat interaction automatically. Call server 320 acts according to the given classification, and only a small percentage of repeat interactions are polled for the source and reason to provide a check on system accuracy, and monitor the need to change and improve the model setup. In some embodiments, periodical analysis of the most misclassified reasons is performed, and adjustment of the setup or retrieved information is performed accordingly. In certain embodiments, the models can be re-trained and examined on a continuous basis.

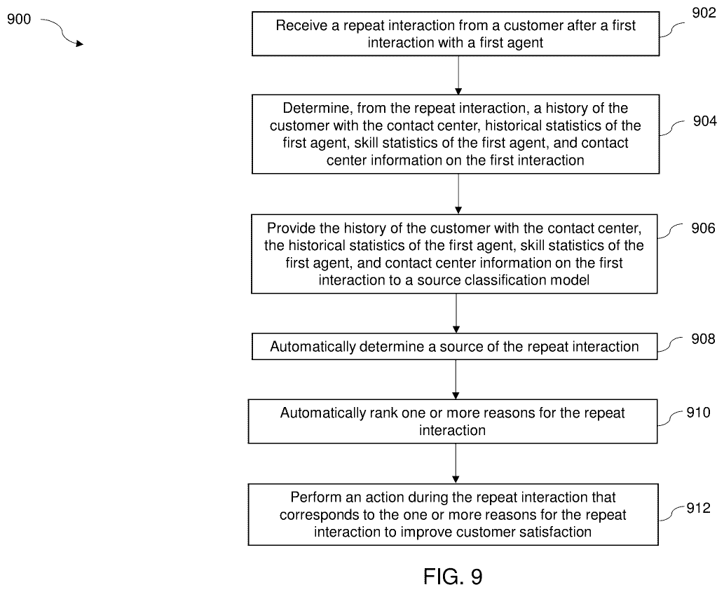

Referring now to FIG. 9, a method 900 according to various embodiments of the present disclosure is described. At step 902, contact center 100 receives a repeat interaction from a customer after a first interaction with a first agent. For example, a customer may call contact center 100 a second time if an issue was not resolved after the first call.

At step 904, call server 320 determines, from the repeat interaction, a history of the customer with the contact center 100, historical statistics of the first agent, skill statistics of the first agent, and contact center information on the first interaction. In other words, metadata associated with the first interaction, the repeat interaction, or both are retrieved or provided to call server 320. Such metadata can include scores (e.g., numeric data related to agent performance), interaction data (e.g., interaction ID, local start time, local stop time, GMT start time, GMT stop time interaction duration, open reason, close reason, switch ID, user ID, interaction type, media type, dialed number (ANI), participants, contact ID, contact start time, and/or call ID), and agent metadata (e.g., ID, tenant ID, CRM reference, gender ID, first name, last name, address, birth date, seniority, nationality, state of origin, and/or OS login), or any combination of the foregoing.

In various embodiments, referring back to FIG. 5, the history of the customer with the contact center 100 includes a contact information sequence, including an agent skill involved in a historical interaction, the time in between interactions, the duration of each interaction, the direction (e.g., inbound call or outbound call), and the agent involved in each interaction. In some embodiments, the historical statistics of the first agent include, for the relevant agent skill, the percentage of incomplete communication, the percentage of lacking skills/proficiency, and the percentage of incorrect information on previous interactions. In several embodiments, the skill statistics of the first agent, for the relevant agent skill, include the percentage of issues due to the customer, the percentage of issues due to the agent, and the percentage of skills due to the contact center. In one or more embodiments, the contact center information includes whether, for the first interaction, a ticket was opened for the issue, the ticket target SLA, whether the issue was assigned to a technician, whether the SLA was reached, and whether an updated SMS was sent.

At step 906, as shown in FIG. 8, the repeat interaction inputs of the history of the customer with the contact center 100, the historical statistics of the first agent, the skill statistics of the first agent, and the contact center information on the first interaction are provided to a source classification model employed in decision engine 322.

In various embodiments, as shown in FIGS. 6 and 7, the history of the customer with the contact center 100, the historical statistics of the first agent, the skill statistics of the first agent, and the contact center information is first transformed into a single vector, and the single vector is provided to the source classification model. In several embodiments, this transformation includes concatenating and vectorizing the history of the customer with the contact center 100, the historical statistics of the first agent, and the skill statistics of the first agent to produce a sequence of concatenated vectors, providing the sequence of concatenated vectors to an RNN (e.g., LSTN) to produce a vector, vectorizing the contact center information on the first interaction, and concatenating the vector to the vectorized contact center information to produce the single vector.

At step 908, the source classification model automatically determines a source of the repeat interaction. For example, the source of the repeat interaction may be a customer-related factor, an agent-related factor, or a contact center-related factor. In one embodiment, the source of the repeat interaction is determined to be an agent-related factor, and the first agent is assigned training, a repeat interaction KPI of the first agent is modified, or both.

In one or more embodiments, as can be seen in FIG. 8, this determination includes outputting, by the source classification model, a probability for each source of a plurality of sources. The probability indicates a likelihood that each source is a cause of the repeat interaction. In some embodiments, which source has a probability greater than a threshold probability is determined and each source having a probability greater than the threshold probability is determined to be a source of the repeat interaction.

In several embodiments, the source classification model and one or more reason ranking models are trained. In certain embodiments, this training includes evaluating an accuracy of the source classification model and the reason ranking model(s) until the accuracy reaches a threshold value. In some embodiments, the method further includes periodically verifying an accuracy of the source classification model and the reason ranking model(s).

At step 910, a reason ranking model automatically ranks, based on the determined source of the repeat interaction, one or more reasons for the repeat interaction.

At step 912, call server 320 performs an action during the repeat interaction that corresponds to the one or more reasons for the repeat interaction to improve customer satisfaction. In one or more embodiments, call server 320 opens a reconnection buffer period after the first interaction, determines that the repeated interaction was initiated within the reconnection buffer period, and the performed action is reconnecting the customer to the first agent.

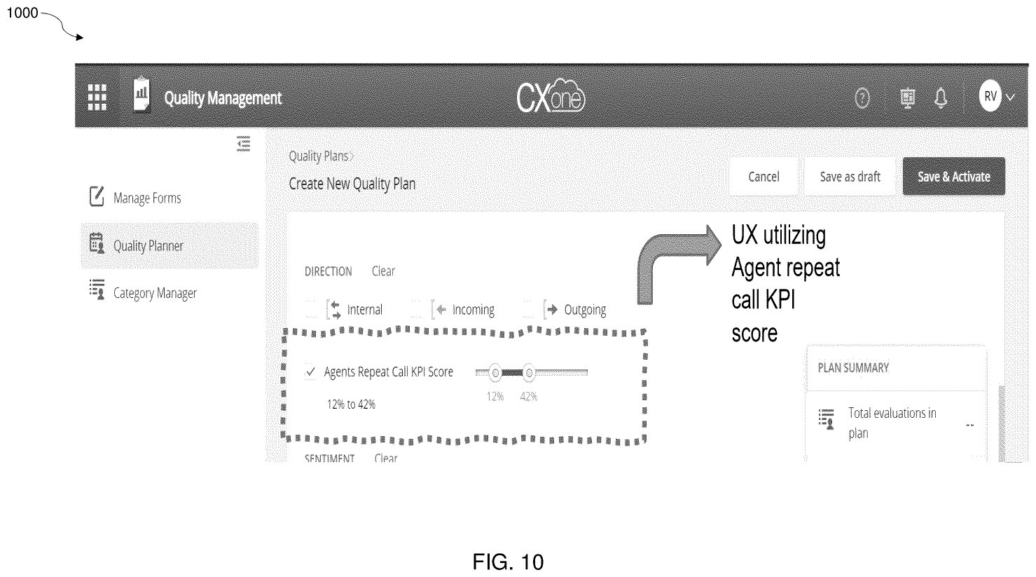

Referring now to FIG. 10, shown is a user interface 1000 that can be used by a quality manager or supervisor to configure the quality plan to select a specific range of agents repeat call KPI score from the slider as shown. This is utilized as a filter when distributing interactions for evaluation activities.

As shown, the quality plan only distributes those recorded interactions in which agents' repeat interaction KPI scores lie within 12-42%, which is helpful because it can act as a datapoint for the evaluator to perform evaluations for root cause into performance issues and lack of knowledge, assignment of coaching/training program for further improvement, and additional call outs for recognition using gamification.

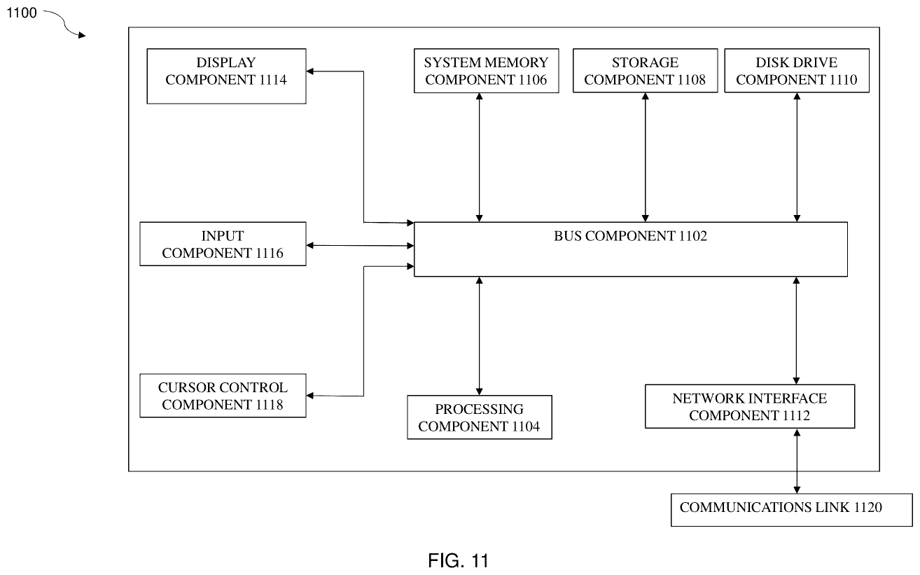

Referring now to FIG. 11, illustrated is a block diagram of a system 1100 suitable for implementing embodiments of the present disclosure. System 1100, such as part of a computer and/or a network server, includes a bus 1102 or other communication mechanism for communicating information, which interconnects subsystems and components, including one or more of a processing component 1104 (e.g., processor, micro-controller, digital signal processor (DSP), etc.), a system memory component 1106 (e.g., RAM), a static storage component 1108 (e.g., ROM), a network interface component 1112, a display component 1114 (or alternatively, an interface to an external display), an input component 1116 (e.g., keypad or keyboard), and a cursor control component 1118 (e.g., a mouse pad).

In accordance with embodiments of the present disclosure, system 1100 performs specific operations by processor 1104 executing one or more sequences of one or more instructions contained in system memory component 1106. Such instructions may be read into system memory component 1106 from another computer readable medium, such as static storage component 1108. These may include instructions to receive, by a contact center, a repeat interaction from a customer after a first interaction with a first agent; determine, from the repeat interaction, a history of the customer with the contact center, historical statistics of the first agent, skill statistics of the first agent, and contact center information on the first interaction; provide the history of the customer with the contact center, the historical statistics of the first agent, the skill statistics of the first agent, and the contact center information on the first interaction to a source classification model; automatically determine, by the source classification model, a source of the repeat interaction; automatically rank, by a reason ranking model, based on the determined source of the repeat interaction, one or more reasons for the repeat interaction; and perform an action during the repeat interaction that corresponds to the one or more reasons for the repeat interaction to improve customer satisfaction. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1104 for execution. Such a medium may take many forms, including but not limited to, non-volatile media, volatile media, and transmission media. In various implementations, volatile media includes dynamic memory, such as system memory component 1106, and transmission media includes coaxial cables, copper wire, and fiber optics, including wires that comprise bus 1102. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1100. In various other embodiments, a plurality of systems 1100 coupled by communication link 1120 (e.g., LAN, WLAN, PTSN, or various other wired or wireless networks) may perform instruction sequences to practice the disclosure in coordination with one another. Computer system 1100 may transmit and receive messages, data, information and instructions, including one or more programs (i.e., application code) through communication link 1120 and communication interface 1112. Received program code may be executed by processor 1104 as received and/or stored in disk drive component 1110 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A classification and resolution system comprising:
a processor and a computer readable medium operably coupled thereto, the computer readable medium comprising a plurality of instructions stored in association therewith that are accessible to, and executable by, the processor, to perform operations which comprise:
receiving, by a contact center, a repeat interaction from a customer after a first interaction with a first agent;
determining, from the repeat interaction, a history of the customer with the contact center, historical statistics of the first agent, skill statistics of the first agent, and contact center information on the first interaction;
providing the history of the customer with the contact center, the historical statistics of the first agent, the skill statistics of the first agent, and the contact center information on the first interaction to a source classification model;
automatically determining, by the source classification model, a source of the repeat interaction;
automatically ranking, by a reason ranking model, based on the determined source of the repeat interaction, one or more reasons for the repeat interaction; and
performing an action during the repeat interaction that corresponds to the one or more reasons for the repeat interaction to improve customer satisfaction.

2. The classification and resolution system of claim 1, wherein the source of the repeat interaction comprises a customer-related factor, an agent-related factor, or a contact center-related factor.

3. The classification and resolution system of claim 2, wherein the source of the repeat interaction is determined to be an agent-related factor, and the operations further comprise assigning training to the first agent, modifying a repeat interaction key performance indicator (KPI) of the first agent, or both.

4. The classification and resolution system of claim 1, wherein the operations further comprise:
opening a reconnection buffer period after the first interaction;
determining the repeated interaction was initiated within the reconnection buffer period; and
reconnecting the customer to the first agent.

5. The classification and resolution system of claim 1, wherein:
the operations further comprise transforming the history of the customer with the contact center, the historical statistics of the first agent, the skill statistics of the first agent, and the contact center information on the first interaction into a single vector, and
the single vector is provided to the source classification model.

6. The classification and resolution system of claim 5, wherein transforming the history of the customer with the contact center, the historical statistics of the first agent, the skill statistics of the first agent, and the contact center information on the first interaction into a source classification model into a single vector comprises:
concatenating and vectorizing the history of the customer with the contact center, the historical statistics of the first agent, and the skill statistics of the first agent to produce a sequence of concatenated vectors;
providing the sequence of concatenated vectors to a recurrent neural network to produce a vector;
vectorizing the contact center information on the first interaction; and
concatenating the vector to the vectorized contact center information to produce the single vector.

7. The classification and resolution system of claim 1, wherein automatically determining a source of the repeat interaction comprises:
outputting, by the source classification model, a probability for each source of a plurality of sources, wherein the probability indicates a likelihood that each source is a cause of the repeat interaction;
determining which source has a probability greater than a threshold probability; and
determining that each source having a probability greater than the threshold probability is a source of the repeat interaction.

8. The classification and resolution system of claim 1, wherein the operations further comprise training the source classification model and the reason ranking model.

9. The classification and resolution system of claim 8, wherein training the source classification model and the reasons ranking model comprises evaluating an accuracy of the source classification model and the reason ranking model until the accuracy reaches a threshold value.

10. The classification and resolution system of claim 1, wherein the operations further comprise periodically verifying an accuracy of the source classification model and the reason ranking model.

11. A method for increasing first call resolution and improving customer satisfaction, which comprises:
receiving, by a contact center, a repeat interaction from a customer after a first interaction with a first agent;
determining, from the repeat interaction, a history of the customer with the contact center, historical statistics of the first agent, skill statistics of the first agent, and contact center information on the first interaction;
providing the history of the customer with the contact center, the historical statistics of the first agent, the skill statistics of the first agent, and the contact center information on the first interaction to a source classification model;
automatically determining, by the source classification model, a source of the repeat interaction;
automatically ranking, by a reason ranking model, based on the determined source of the repeat interaction, one or more reasons for the repeat interaction; and
performing an action during the repeat interaction that corresponds to the one or more reasons for the repeat interaction to improve customer satisfaction.

12. The method of claim 11, which further comprises:
transforming the history of the customer with the contact center, the historical statistics of the first agent, the skill statistics of the first agent, and the contact center information on the first interaction into a single vector, and
the single vector is provided to the source classification model.

13. The method of claim 12, wherein transforming the history of the customer with the contact center, the historical statistics of the first agent, the skill statistics of the first agent, and the contact center information on the first interaction into a source classification model into a single vector comprises:
concatenating and vectorizing the history of the customer with the contact center, the historical statistics of the first agent, and the skill statistics of the first agent to produce a sequence of concatenated vectors;
providing the sequence of concatenated vectors to a recurrent neural network to produce a vector;
vectorizing the contact center information on the first interaction; and
concatenating the vector to the vectorized contact center information to produce the single vector.

14. The method of claim 11, wherein automatically determining a source of the repeat interaction comprises:
outputting, by the source classification model, a probability for each source of a plurality of sources, wherein the probability indicates a likelihood that each source is a cause of the repeat interaction;
determining which source has a probability greater than a threshold probability; and
determining that each source having a probability greater than the threshold probability is a source of the repeat interaction.

15. The method of claim 11, which further comprises training the source classification model and the reason ranking model.

16. A non-transitory computer-readable medium having stored thereon computer-readable instructions executable by a processor to perform operations which comprise:
receiving, by a contact center, a repeat interaction from a customer after a first interaction with a first agent;
determining, from the repeat interaction, a history of the customer with the contact center, historical statistics of the first agent, skill statistics of the first agent, and contact center information on the first interaction;
providing the history of the customer with the contact center, the historical statistics of the first agent, the skill statistics of the first agent, and the contact center information on the first interaction to a source classification model;
automatically determining, by the source classification model, a source of the repeat interaction;
automatically ranking, by a reason ranking model, based on the determined source of the repeat interaction, one or more reasons for the repeat interaction; and
performing an action during the repeat interaction that corresponds to the one or more reasons for the repeat interaction to improve customer satisfaction.

17. The non-transitory computer-readable medium of claim 16, wherein:
the operations further comprise transforming the history of the customer with the contact center, the historical statistics of the first agent, the skill statistics of the first agent, and the contact center information on the first interaction into a single vector, and
the single vector is provided to the source classification model.

18. The non-transitory computer-readable medium of claim 17, wherein transforming the history of the customer with the contact center, the historical statistics of the first agent, the skill statistics of the first agent, and the contact center information on the first interaction into a source classification model into a single vector comprises:
concatenating and vectorizing the history of the customer with the contact center, the historical statistics of the first agent, and the skill statistics of the first agent to produce a sequence of concatenated vectors;
providing the sequence of concatenated vectors to a recurrent neural network to produce a vector;
vectorizing the contact center information on the first interaction; and
concatenating the vector to the vectorized contact center information to produce the single vector.

19. The non-transitory computer-readable medium of claim 16, wherein automatically determining a source of the repeat interaction comprises:
outputting, by the source classification model, a probability for each source of a plurality of sources, wherein the probability indicates a likelihood that each source is a cause of the repeat interaction;
determining which source has a probability greater than a threshold probability; and
determining that each source having a probability greater than the threshold probability is a source of the repeat interaction.

20. The non-transitory computer-readable medium of claim 16, wherein the operations further comprise training the source classification model and the reason ranking model.
